(19) United States
(12) Patent Application Publication
(10) Pub. No.: US 2009/0324192 A1
(43) Pub. Date: Dec. 31, 2009

(54) INFORMATION REPRODUCTION DEVICE AND METHOD AND COMPUTER PROGRAM

(75) Inventors: Koji Ogura, Tokorozawa-shi (JP); Youichi Yamada, Tokorozawa-Shi (JP); Takao Yamada, Tokorozawa-Shi (JP); Nobuo Ohyama, Tokorozawa-Shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/281,214

(22) PCT Filed: Mar. 1, 2007
(86) PCT No.: PCT/JP2007/053878

§ 371 Date: Oct. 31, 2008

(30) Foreign Application Priority Data
Mar. 1, 2006 (JP) 2006-054714

(51) Int. Cl. H04N 5/91

(52) U.S. Cl. 386/66; 386/E05.003

(57) ABSTRACT

An information reproduction device (40) includes: reproduction means (16) for reproducing content data containing video data and audio data; specification means (411, 412) for specifying a reproduction start time and a reproduction end time of the content data portion; first control means (20) for controlling the reproduction means so as to loop-reproduce the content data portion; second control means (20) for controlling the reproduction means so as to inverse the reproduction direction along the time axis of the video data contained in the content data portion at the loop reproduction end of the content data portion; and third control means (20) for controlling reproduction means so as to reproduce the audio data contained in the content data portion at the loop reproduction end of the content data portion from the reproduction start time.

### TECHNICAL FIELD

The present invention relates to an information reproducing apparatus and method, such as DJ equipment, and a computer program which makes a computer function as such an information reproducing apparatus.

### BACKGROUND ART

Recently, a recording medium which allows data recording and data reproduction by using a digital signal, such as a CD and a DVD, has been spread. Along with that, an information reproducing apparatus, which performs a unique reproduction process due to the digital signal, is also under development. For example, into a CD and a DVD, a plurality of music pieces (i.e. content data) are recorded in association with each other. More specifically, for example, music pieces, each having a predetermined reproduction time length, are recorded as a plurality of data groups which can be distinguished by track numbers. Thus, the information reproducing apparatus can perform cue-reproduction which searches for a head address of each music piece and reproduces it, random-reproduction which arbitrarily changes the reproduction order of each music piece, or the like.

Moreover, by using two or more information reproducing apparatuses and performing continuous reproduction while matching the position, interval, intensity, or the like of a beat of a music piece to be reproduced on each information reproducing apparatus, it is possible to reproduce two or more music pieces as if they were a continuous one music piece, or to overlap and reproduce the two or more music pieces. That is, it is possible to reproduce a plurality of music pieces, continuously or simultaneously, without making an audience feel uncomfortable. Such an operation is generally referred to as a mixing operation.

Such random reproduction and mixing reproduction or the like are performed by an user's operation of rotating a jog dial, for example. Moreover, as the information reproducing apparatus which is provided with the jog dial, DJ (Disc Jockey) equipment or the like is considered to be its representative example.

On the other hand, there is disclosed such an optical disc reproducing apparatus that can perform repetitive reproduction without stopping the reproduction during a search operation (refer to a patent document 1). This optical disc reproducing apparatus is provided with a first memory and a second memory. By starting the reproduction of contents which is stored in the first memory after the reproduction of contents which is stored in the second memory is ended, it is possible to eliminate a discontinuous reproduction sound during the repetitive reproduction operation (i.e. while a pickup is displaced from the end address of contents to the start address of the contents).
Patent document 1: Japanese Patent Application Laid Open NO. Hei 7-65506

### DISCLOSURE OF INVENTION

### Subject to be Solved by the Invention

On the aforementioned optical disc reproducing apparatus, however, because the contents are kept to be reproduced from the start address to the end address, after the reproduction is ended up to the end address, the contents are reproduced again from the start address. Thus, in particular, it has such a technical problem that it is hard to ensure the continuity of video contents (i.e. seamless reproduction).

The subject to be solved by the present invention includes the aforementioned problem as one example. It is therefore an object of the present invention to provide an operating apparatus and a reproducing apparatus which allow the seamless repetitive reproduction.

### Means for Solving the Subject

(Information Reproducing Apparatus)

The above object of the present invention can be achieved by an information reproducing apparatus provided with: a reproducing device for reproducing content data including video data and audio data; a specifying device for specifying a reproduction start time point and a reproduction end time point of a content data portion, which is at least one portion of the content data; a first controlling device for controlling the reproducing device to loop-reproduce the content data portion after the reproduction start time point and the reproduction end time point are specified by the specifying device; a second controlling device for controlling the reproducing device to reverse a reproduction direction along a time axis of the video data included in the content data portion, at an edge portion of the loop-reproduction of the content data portion; and a third controlling device for controlling the reproducing device to reproduce the audio data included in the content data portion from the reproduction start time point, at an end edge of the loop-reproduction of the content data portion.

According to the information reproducing apparatus of the present invention, by the operation of the reproducing device, the content data including e.g. video images and audio can be reproduced.

In particular, in the present invention, by the operation of the specifying device, the reproduction start time point and the reproduction end time point of the content data portion, which is at least one portion of the content data, are specified. In other words, the reproduction start time point (i.e. reproduction start position) and the reproduction end time point (i.e. reproduction end position) of the content data portion are specified to perform loop-reproduction described later.

Then, for example, if an instruction to perform the loop-reproduction is given from a user, the loop-reproduction (in other words, repetitive reproduction) is performed on the content data portion which is specified by the specified reproduction start time point and the specified reproduction end time point, by the operation of the first controlling device.

At this time, the reproduction direction of the video data of the content data portion is reversed at the edge portion(s) (in other words, a start edge and an end edge) of the loop-reproduction of the content data portion, by the operation of the second controlling device.

More specifically, by the operation of the second controlling device, if the forward-reproduction (i.e. reproduction directed in the forward direction which runs along the reproduction time axis of the content data) is being performed on the video data of the content data portion, the reverse-reproduction (i.e. reproduction directed in the reverse direction which runs counter to the reproduction time axis of the content data) is performed on the video data of the content data portion at the edge portion(s) of the loop reproduction specified by the reproduction start time point and the reproduction end time point. On the other hand, if the reverse-reproduction is being performed on the video data of the content data portion, the forward-reproduction is performed on the video data of the content data portion at the edge portion(s) of the loop-reproduction specified by the reproduction start time point and the reproduction end time point. Thus, for example, if the video data of the content data portion indicates video image in which a person walks forward from the left edge to the right edge of a screen, the video image in which the person walks forward from the left edge to the right edge of the screen is reproduced, and then the video image in which the person walks backward from the right edge to the left edge of a screen is reproduced, by the operations of the first controlling device and the second controlling device. When the person reaches the left edge of the screen, the video image in which the person walks forward from the left edge to the right edge of the screen is reproduced again. Then, the video image is repeatedly reproduced as long as the loop-reproduction is performed.

On the other hand, by the operation of the third controlling device, the reproduction position of the audio data of the content data is set to the reproduction start time point at the end edge of the loop-reproduction of the content data portion.

More specifically, by the operation of the third controlling device, if the forward-reproduction is performed on the audio data of the content data portion, the reproduction of the audio data of the content data portion is set to the reproduction start time point at the end edge of the loop-reproduction specified by the reproduction end time point. As a result, the forward-reproduction is performed again from the reproduction start time point, on the audio data of the content data portion that is once reproduced until the reproduction end time point. Thus, the audio data of the content data portion is reproduced in the forward direction along the reproduction time axis without being reverse-reproduced. Then, the audio is repeatedly reproduced as long as the loop-reproduction is performed.

As described above, according to the information reproducing apparatus of the present invention, since the reproduction direction of the video data is reversed at the edge portion(s) of the loop-reproduction, it is possible to particularly realize the reproduction with the seamless video image. Therefore, the user can reproduce or watch video image which is comfortable and whose flow does not stop unnaturally. That is, it is possible to realize the seamless loop-reproduction.

On the other hand, as for audio, since the loop-reproduction is performed without the reproduction direction being reversed, it is possible to eliminate that the audio is unnaturally reproduced (specifically, reproduced in the reverse direction) in the middle of the loop-reproduction. Thus, the user can perform the loop-reproduction of audio without reversing a flow of audio unnaturally. That is, it is possible to perform the loop-reproduction of audio which is seamless or comfortable.

As described above, according to the information reproducing apparatus of the present invention, it is possible to loop-reproduce the video data and the audio data of the content data portion, nonsimultaneously (in other words, individually and independently). Thus, it is possible to loop-reproduce the content data portion including the video data and the audio data, seamlessly or comfortably.

In addition, the user can perform the loop-reproduction on the content data portion without any other complicate operations as long as the reproduction start time point and the reproduction end time point is merely specified. Thus, the user can perform the loop-reproduction by the relatively easy operation.

Moreover, since it is possible to extract an arbitrary content data portion in the content data reproduced in real time, the user can perform the loop-reproduction in any timing on the desired content data portion.

Moreover, if the content data portion is regarded as what is extracted as a first material, another effect process can be further added to the content data portion while performing the loop-reproduction of the content data potion. That is, by using the content data portion extracted as the first material, it is possible to reproduce the content data portion as a second material to which the effect process is added. Thus, it is possible to reproduce the content data portion (or content data) in a more special aspect or in an aspect of appealing to a viewer.

In one aspect of the information reproducing apparatus of the present invention, the second controlling device controls the reproducing device to reverse the reproduction direction along the time axis of the video data included in the content data portion, with using the reproduction start time point, the reproduction end time point, and an intermediate time point, as the edge portion of the loop-reproduction.

According to this aspect, if the video data is forward-reproduced, the audio data is forward-reproduced. That is, it is possible to match the reproduction cycle of the video data and the reproduction cycle of the audio data.

In another aspect of the information reproducing apparatus of the present invention, the second controlling device controls the reproducing device to reverse-reproduce the video data from the reproduction end time point to the reproduction start time point after the reproduction end time point passes, if the video data is forward-reproduced from the reproduction start time point to the reproduction end time point, and controls the reproducing device to forward-reproduce the video data from the reproduction start time point to the reproduction end time point after the reproduction start time point passes, if the video data is reverse-reproduced from the reproduction end time point to the reproduction start time point.

According to this aspect, it is possible to preferably perform the loop-reproduction in which the reproduction direction of video image is reversed in the edge portion(s).

In another aspect of the information reproducing apparatus of the present invention, it is further provided with a stopping device for stopping the loop-reproduction of the content data portion.

According to this aspect, it is possible to start or stop the loop-reproduction in any timing. If the loop-reproduction is not performed, the normal reproduction of the content data is performed.

In another aspect of the information reproducing apparatus of the present invention, it is further provided with a storing device for storing the content data portion.

According to this aspect, it is possible to use the content data portion which is stored in the storing device, such as a memory, when the loop-reproduction is performed. By this, it is unnecessary to obtain the content data point by point from an information recording medium external to the information reproducing apparatus. Thus, it is possible to relatively reduce a processing load of the information reproducing apparatus.

In addition, by storing the content data portion in the storing device, it is possible to preferably reproduce the content data portion as the second material to which the effect process is added, by using the content data portion which is extracted as the first material.

In another aspect of the information reproducing apparatus of the present invention, it is further provided with: an inputting device for receiving external input for specifying an aspect of reproduction of the content data; and a fourth controlling device for controlling the reproducing device to reproduce the content data portion in an aspect according to the external input received by the inputting device while performing the loop-reproduction by the control of the first controlling device.

According to this aspect, by the operation of the fourth controlling device, it is possible to preferably add another effect process (e.g. increasing or reducing tempo, scratching, or the like) according to the external input, to the content data portion while performing the loop-reproduction of the content data portion.

In another aspect of the information reproducing apparatus of the present invention, it is further provided with a fifth controlling device for controlling the reproducing device to reproduce the content data portion while performing a predetermined effect process on the content data portion and while performing the loop-reproduction by the control of the first controlling device.

According to this aspect, by the operation of the fifth controlling device, it is possible to preferably add another effect process (e.g. increasing or reducing tempo, scratching, or the like) set in default, for example, to the content data portion while performing the loop-reproduction of the content data portion.

(Information Reproducing Method)

The above object of the present invention can be also achieved by an information reproducing method on an information reproducing apparatus provided with: a reproducing device for reproducing content data including video data and audio data; and a specifying device for specifying a reproduction start time point and a reproduction end time point of a content data portion, which is at least one portion of the content data, the information reproducing method provided with: a first controlling process of controlling the reproducing device to loop-reproduce the content data portion after the reproduction start time point and the reproduction end time point are specified by the specifying device; a second controlling process of controlling the reproducing device to reverse a reproduction direction along a time axis of the video data included in the content data portion, at edge portion of the loop-reproduction of the content data portion; and a third controlling process of controlling the reproducing device to reproduce the audio data included in the content data portion from the reproduction start time point, at an end edge of the loop-reproduction of the content data portion.

According to the information reproducing method of the present invention, it is possible to receive the same benefits as those of the aforementioned information reproducing apparatus of the present invention.

Incidentally, in response to the aforementioned various aspects of the information reproducing apparatus of the present invention, the information reproducing method of the present invention can also employ various aspects.

(Computer Program)

The above object of the present invention can be also achieved by a computer program for reproduction control and for controlling a computer provided in the information reproducing apparatus of the present invention described above (including its various aspects), the computer program making the computer function as at least one portion of the first controlling device, the second controlling device, and the third controlling device.

According to each of the computer program of the present invention, the aforementioned information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned information reproducing apparatus of the present invention, the computer program of the present invention can also employ various aspects.

The above object of the present invention can be also achieved by a computer program product in a computer-readable medium for tangibly embodying a program of instructions executable by a computer provided in the aforementioned information reproducing apparatus of the present invention (including its various aspects), the computer program product making the computer function as at least one portion of the first controlling device, the second controlling device, and the third controlling device.

According to the computer program product of the present invention, the aforementioned information reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information reproducing apparatus of the present invention.

Incidentally, in response to the various aspects of the aforementioned information reproducing apparatus of the present invention, the computer program product of the present invention can also employ various aspects.

These effects and other advantages of the present invention will become more apparent from the embodiments explained below.

As explained above, according to the information reproducing apparatus of the present invention, it is provided with the reproducing device, the specifying device, the first controlling device, and the second controlling device. According to the information reproducing method of the present invention, it is provided with the first controlling process and the second controlling process. According to the computer program of the present invention, it makes a computer function as the information reproducing apparatus of the present invention. Therefore, it is possible to perform the seamless repetitive reproduction.

### BRIEF DESCRIPTION OF DRAWINGS

FIG. 1 is a block diagram conceptually showing the basic structure of an optical disc reproducing apparatus in an embodiment.

FIG. 2 is a plan view conceptually showing, in particular, the appearance of an operation device of the optical disc reproducing apparatus in the embodiment.

FIG. 3 is a flowchart conceptually showing a flow of a first operation example when the optical disc reproducing apparatus in the embodiment performs loop-reproduction.

FIG. 4 is a timing chart conceptually showing content data portion specified by a loop-in point and a loop-out point.

FIG. 5 are a timing chart conceptually showing a reproduction position in performing the loop-reproduction in the first operation example, and a plan view conceptually showing an aspect of displaying video images in performing the loop-reproduction in the first operation example.

FIG. 6 is one timing chart conceptually showing the reproduction position in performing the loop-reproduction in a modified example.

FIG. 7 are other timing charts conceptually showing the reproduction position in performing the loop-reproduction in modified examples.

FIG. 8 is a flowchart conceptually showing a flow of a second operation example when the optical disc reproducing apparatus performs the loop-reproduction.

FIG. 9 is a timing chart conceptually showing the reproduction position in performing the loop-reproduction in a second embodiment.

FIG. 10 is a waveform chart conceptually showing the reproduction position in performing the loop-reproduction in the second embodiment.

FIG. 11 is a timing chart conceptually showing the waveform of audio in performing the loop-reproduction in the second embodiment.

### DESCRIPTION OF REFERENCE CODES

1 optical disc reproducing apparatus
10 optical disc
11 RF amplifier
15 content data decoding device
16 decoding device
20 system controller
24 buffer memory
40 operation device
41 jog dial
43 tempo slider
411 loop-in point specification button
412 loop-out point specification button
413 loop reproduction start/stop button
414 effect addition button

### BEST MODE FOR CARRYING OUT THE INVENTION

Hereinafter, the best mode for carrying out the present invention will be explained in each embodiment in order with reference to the drawings. Incidentally, in embodiments below, the information reproducing apparatus of the present invention is applied to an optical disc reproducing apparatus, such as a CD player or a DVD player, which has various reproduction functions represented by reproduction speed control, tempo control, fast-rewind reproduction, or the like. Moreover, the optical disc reproducing apparatus in the embodiments explained below is used as DJ equipment used when music data or video data are continuously reproduced while various special effects (or effects) are added to the data at a dance place, such as a club and a disco. Incidentally, the “DJ” in the embodiments is a concept including to reproduce content data in a wide sense, including not only music but also video, in special techniques.

### (1) Basic Structure

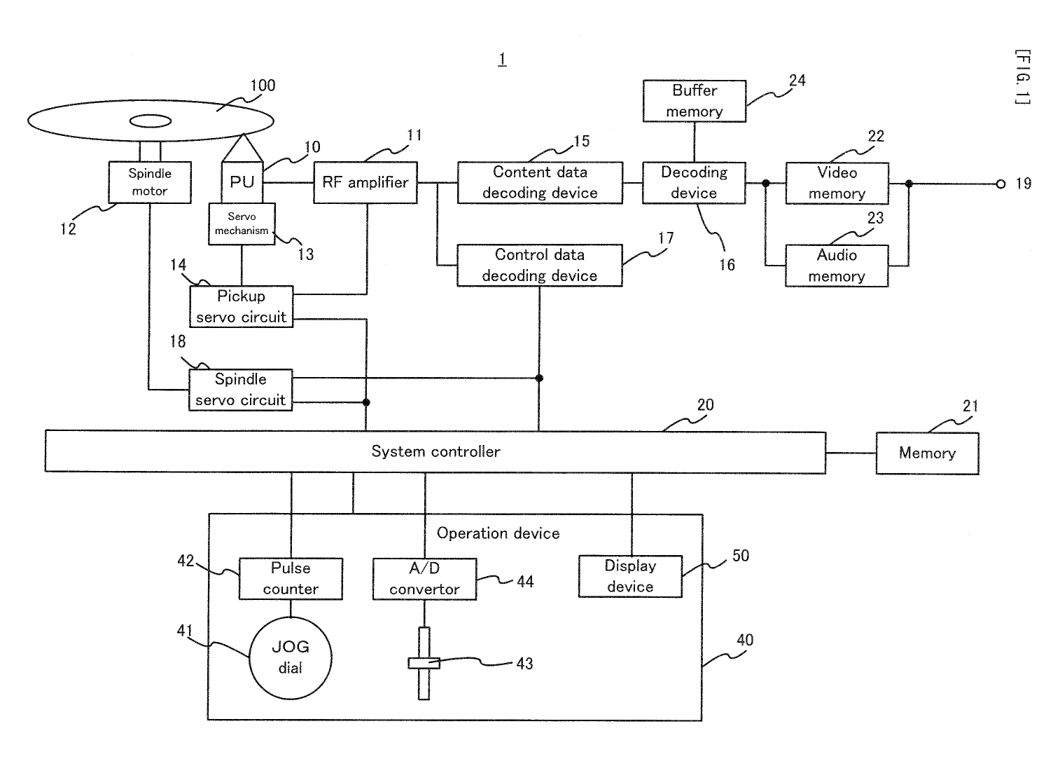

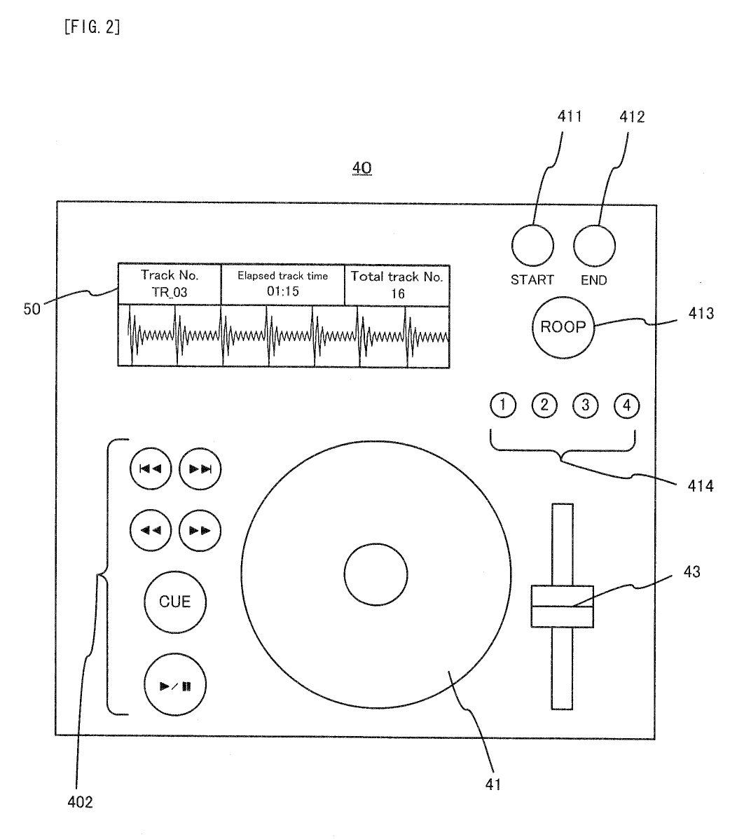

Firstly, with reference to FIG. 1 and FIG. 2, the basic structure of the optical disc reproducing apparatus in the embodiment will be explained. FIG. 1 is a block diagram conceptually showing the basic structure of the optical disc reproducing apparatus in the embodiment. FIG. 2 is a plan view conceptually showing, in particular, the appearance of an operation device of the optical disc reproducing apparatus in the embodiment.

As shown in FIG. 1, an optical disc reproducing apparatus 1 is provided with: an optical pickup (PU: Pick Up) 10; a RF (Radio Frequency) amplifier 11; a spindle motor 12; a servo mechanism 13; a pickup servo circuit 14; a content data decoding device 15; a decoding device 16; a control data decoding device 17; a spindle servo circuit 18; an external output terminal 19; a system controller 20; a memory 21; a video memory 22; an audio memory 23; a buffer memory 24; an operation device 40; and a display device 50.

The optical pickup 10 is to read content data and control data from the optical disc 100, and it is formed of a semiconductor laser apparatus, various lenses, an actuator and the like. More specifically, the optical pickup 10 irradiates the optical disc 100 with a laser beam LB at a predetermined power. Moreover, the optical pickup 10 is provided with a PD (Photo Detector) sensor for receiving the reflective light of the laser beam LB from the optical disc 100, and it outputs the received reflective light as a reading signal to the RF amplifier 11.

The optical pickup 10 is adapted to be displaced in the radial direction or the like of the optical disc 100 in accordance with a tracking error signal, by a not-illustrated actuator, slider, or the like driven by the control of the servo mechanism 13. In addition, by the control of the servo mechanism 13, the optical pickup 10 is adapted to change the focal point of the laser beam LB and to perform focus control in accordance with a focus error signal.

The RF amplifier 11 generates a RF signal on the basis of the reading signal outputted from the optical pickup 10 and outputs the generated RF signal to each of the content data decoding device 15 and the control data decoding device 17. Moreover, the RF amplifier 11 generates an error signal, such as a focus error signal for controlling the focus when the optical pickup 10 irradiates the optical disc 100 with the laser beam LB and a tracking error signal for controlling the tracking when the optical pickup 10 irradiates the optical disc 100 with the laser beam LB, on the basis of the reading signal outputted from the optical pickup 10. The generated error signal is outputted to the pickup servo circuit 14.

The spindle motor 12 is adapted to rotate the optical disc 100 at a predetermined speed under the spindle servo by the spindle servo circuit 18.

The servo mechanism 13 displaces the optical pickup 10 in the radial direction of the optical disc 100, on the basis of a tracking servo control signal outputted from the pickup servo circuit 14. Moreover, on the basis of a focus servo control signal outputted from the pickup servo circuit 14, the servo mechanism 13 displaces an objective lens included in the optical pickup 10 along the optical axis of the laser beam LB.

The pickup servo circuit 14 generates the focus servo control signal and the tracking servo control signal for controlling the servo mechanism 13, on the basis of the error signal outputted from the RF amplifier 11. The focus servo control signal and the tracking servo control signal which are generated are outputted to the servo mechanism 13. In other words, in order to inhibit the generation of a focus error and a tracking error, the pickup servo circuit 14 feedback-controls the servo mechanism 13 on the basis of the error signal outputted from the RF amplifier 11.

The content data decoding device 15 decodes the RF signal outputted from the RF amplifier 11, to thereby generate a stream signal including a video stream and an audio stream. The generated stream signal is outputted to the decoding device 16.

The decoding device 16 constitutes one specific example of the “reproducing device” of the present invention, and it decodes the stream signal and generates a reproduction signal including a video signal and an audio signal. With regard to the generated reproduction signal, the video signal is outputted to the video memory 22, and the audio signal is outputted to the audio memory 23.

The video memory 22 temporarily stores the video signal inputted from the decoding device 16, and then outputs it to external output equipment, such as a display, through the external output terminal 19 in desired timing. The external output equipment, such as a display, displays a video image according to the video signal.

The audio memory 23 temporarily stores the audio signal inputted from the decoding device 16, and then outputs it to external output equipment, such as a speaker, through the external output terminal 19 in desired timing. The external output equipment, such as a speaker, outputs a sound (or music) according to the audio signal.

The buffer memory 24 temporarily buffers the reproduction signal which is generated by decoding the stream signal on the decoding device 16. To the video memory 22 and the audio memory 23, the video signal and the audio signal may be outputted directly from the decoding device 16, or the video signal and the audio signal temporarily stored in the buffer memory 24 may be outputted through the decoding device 16.

Incidentally, the predetermined modulation process may be performed on the reproduction signal outputted from the decoding device 16, and then the modulated reproduction signal may be outputted to the external output equipment. More specifically, for example, modulation by a sawtooth wave may be performed on the reproduction signal. For example, modulation by a rectangle wave may be performed on the reproduction signal. For example, modulation that causes a Doppler effect may be performed on the reproduction signal. For example, modulation by a special waveform that imitates a jet sound may be performed on the reproduction signal. For example, modulation by a special waveform that imitates the bark of a gun may be performed on the reproduction signal. Alternatively, for example, modulation by various special waveforms set in advance by a user or the like may be performed. These modulations are preferably performed by the user's operation of not-illustrated operation key(s) on the operation device 40.

The control data decoding device 17 decodes the RF signal outputted from the RF amplifier 11, to thereby generate the control data for controlling the reproduction of the content data. As the control data, for example, TOC data or the like recorded in a lead-in area of the optical disc 100, synchronization data recorded with it included in the stream signal, sub-code data including time-passage information when the content data is reproduced, or the like are listed as one specific example. The generated control data is outputted to the system controller 20 and is used to control the reproduction of the content data.

The spindle servo circuit 18 detects an error of the synchronization data with respect to the rotational speed of the spindle motor 12 instructed from the system controller 20, and feedback-controls the rotation of the spindle motor 12 in order to inhibit the generation of the error.

The system controller 20 is provided with a microprocessor (MPU), and executes a system program (or firmware or the like) set in advance, to thereby provide central control for the operation of the entire optical disc reproducing apparatus 1.

The memory 21 is provided with a RAM area to temporarily store various data or the like necessary for the operation of the optical disc reproducing apparatus 1, or a ROM area to store the system program or the like for defying the operation of the system controller 20, or the like.

Moreover, the system controller 20 is connected to the operation device 40 and the display device 50. Instruction data from the various operation keys provided for the operation device 40 is outputted to the system controller 20, and the system controller 20 controls the reproduction of the content data in accordance with the instruction data. Moreover, the system controller 20 controls the display operation of the display device 50.

The operation device 40 is provided with: a jog dial 41; a pulse counter 42; a tempo slider 43; an A/D converter 44; and the display device 50.

The jog dial 41 is a disc-shaped operation key which can rotate in both directions. When the user or the like operates the jog dial 41 and changes the rotational direction and rotational speed of the jog dial 41 as occasion demands, forward-reproduction and reverse-reproduction can be set in accordance with the rotational direction, and moreover, the tone of the music reproduced by a speaker or a head phone can be changed in accordance with the rotational speed.

Incidentally, the aforementioned forward-reproduction means the reproduction of the content data on the optical disc 100 in recorded order, as in the case that the music or the like is reproduced while an analog record such as an LP is rotated in a forward direction. Therefore, music or the like is reproduced as a normal sound in accordance with the clockwise rotation of the jog dial 41. Moreover, even while the jog dial 41 is stopped, the forward-reproduction can be performed.

On the other hand, the aforementioned reverse-reproduction means the reproduction of the content data on the optical disc 100 in reverse order opposite to the recorded order, as in the case that the music or the like is reproduced while the analog record is rotated in the reverse direction. Since the music or the like is continuously recorded (or analog-recorded) on the analog record, rotating the analog record in the reverse direction causes the music or the like to be reproduced in the reverse direction, resulting in a reproduced imitation sound, which is different from the original music or the like. If the jog dial 41 is rotated in a counterclockwise direction, the individual content data which is digital-recorded on the optical disc 100 is reproduced in the reverse order. This causes the same imitation sound as in the case that the analog record is rotated and reproduced in the reverse direction.

As described above, because the same function for reverse-reproducing the analog record is provided, if the user or the like repeats the quick reciprocating rotation of the jog dial 41 in the clockwise direction and in the counterclockwise direction, the imitation sound referred to as a so-called scratch sound (i.e. imitation sound such as “squeak” and “bang”) can be generated. Then, when a musical performer referred to as a disk jockey operates the jog dial 41 to generate the aforementioned scratch sound or the like, the disk jockey can perform editing for producing rap music or the like by using a CD and a DVD.

The pulse counter 42 counts the pulse width of a pulse (or the number of pulses or the like) which is generated by the operation of rotating the jog dial 41, to thereby detect the rotational speed (or angular velocity) of the jog dial 41. In addition, on the basis of the pulse generated by the operation of rotating the jog dial 41, the pulse counter 42 detects the rotational direction of the jog dial 41. The detected rotational direction and the detected rotational speed of the jog dial 41 are outputted to the system controller 20. This allows the system controller 20 to recognize an operation amount of the jog dial 41 operated by the user or the like and to perform an effect operation according to the operation amount.

The tempo slider 43 is provided with a slider button which can be slid vertically, for example. By the user or the like displacing the slider button, the reproduction speed of the content data can be changed, as occasion demands. For example, displacing the slider button upward allows the reproduction speed of the content data to be relatively slow, or displacing the slider button downward allows the reproduction speed of the content data to be relatively fast. The travel distance of the slider button is detected as an analog value corresponding to the travel distance and is outputted to the A/D converter 44.

The A/D converter 44 converts the travel distance of the slider button provided for the tempo slider 43, which is detected as the analog value, to a digital value, and then outputs it to the system controller 20. This allows the system controller 20 to relatively increase or reduce the reproduction speed of the content data in accordance with the travel distance of the slide button.

The display device 50 displays various information associated with the reproduction of the content data. The display device 50 is provided with a display panel, such as a liquid crystal display and a fluorescent tube, and displays the various information, under the control of the system controller 20.

As show in FIG. 2, the operation device 40 is provided with: the jog dial 41; operation buttons 402; the tempo slider 43; a loop-in point specification button 411; a loop-out point specification button 412; a loop reproduction start/stop button 413; effect addition buttons 414; and the display device 50, on the appearance.

The operation buttons 402 are buttons that can be pressed by the user. The operation buttons 402 are adapted to change the operation of the optical disc reproducing apparatus 1 by the user's press of the operation buttons 402. Specifically, the user presses the operation buttons 402 to give instructions to reproduce, fast-forward, rewind, and pause the content data and to start the reproduction from a predetermined cue point, or the like.

The loop-in point specification button 411 constitutes one specific example of the “specifying device” of the present invention, and is adapted to specify a loop-in point (in other words, a reproduction start time point or reproduction start position) for performing loop-reproduction described later. If the user presses the loop-in point specification button 411 during the reproduction of the content data, the reproduction time point upon the pressing is specified as the loop-in point.

The loop-out point specification button 412 constitutes one specific example of the “specifying device” of the present invention, and is adapted to specify a loop-out point (in other words, a reproduction end time point or reproduction end position) for performing the loop-reproduction described later. If the user presses the loop-out point specification button 412 during the reproduction of the content data, the reproduction time point upon the pressing is specified as the loop-out point.

The loop reproduction start/stop button 413 constitutes one specific example of the “stopping device” of the present invention, and is adapted to give instructions to start and stop the loop-reproduction of a content data portion which is specified by the loop-in point and the loop-out point. If the loop reproduction start/stop button 413 is pressed when the loop-reproduction is not performed, the loop-reproduction is started. On the other hand, if the loop reproduction start/stop button 413 is pressed when the loop-reproduction is performed, the loop reproduction is stopped, and the normal reproduction of the content data is performed.

The effect addition buttons 414 are buttons which are to be pressed when a special effect process is further performed on the loop-reproduced content data portion.

The display device 50 displays various information according to the reproduction of the content data including music pieces. For example, the display device 50 displays, in the upper part thereof, a track number of the content data which is currently being reproduced, an elapsed time of the content data which is currently being reproduced (i.e. a current reproduction time), the total track number of the content data recorded on the optical disc 100 which is currently loaded in the optical disc reproducing apparatus 1, and the like. In the display example shown in FIG. 2, it is possible to recognize that the content data with a track number of 3 is currently reproduced, that 1 minute 15 seconds have elapsed since the reproduction start, and that the total track number of the content data recorded on the optical disc 100 which is loaded in the optical disc reproducing apparatus 1 is “16”.

Moreover, the display device 50 wave-displays, in the lower part thereof, a beat density of the content data along the reproduction time axis. Alternatively, it may wave-display signal intensity for each frequency band of the content data which is currently being reproduced.

Of course, the display content on the display device 50 shown in FIG. 2 is merely one specific example, and obviously, other various information or the like may be displayed.

### (2) First Operation Example

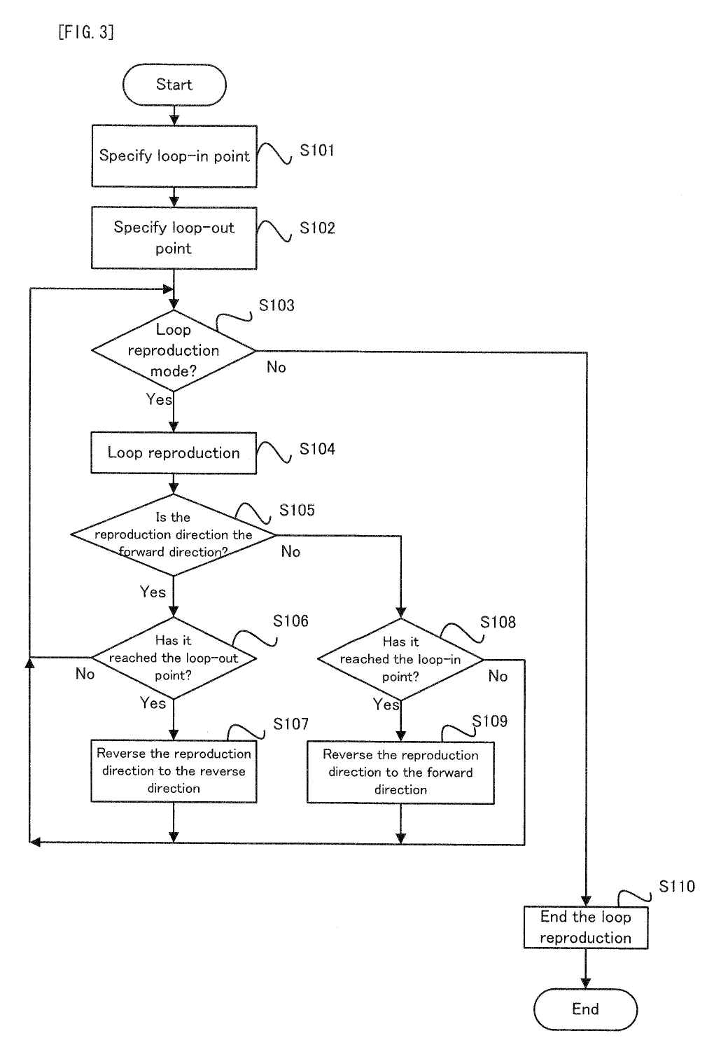

Next, an explanation will be given on a first operation example when the optical disc reproducing apparatus 1 in the embodiment performs the loop-reproduction. FIG. 3 is a flowchart conceptually showing a flow of the first operation example when the optical disc reproducing apparatus 1 in the embodiment performs the loop-reproduction.

As shown in FIG. 3, by using the loop-in point specification button 411, the loop-in point is specified (step S101). In the same manner, by using the loop-out point specification button 412, the loop-out point is specified (step S102).

Then, it is judged whether or not the current reproduction mode is a loop-reproduction mode (step S103). More specifically, it is judged whether or not the loop-reproduction start/stop button 413 is pressed when the loop-reproduction is not performed. If the loop reproduction start/stop button 413 is pressed when the loop-reproduction is not performed, or if the loop-reproduction is continued, it is judged that the current reproduction mode is the loop-reproduction mode. On the other hand, if the loop reproduction start/stop button 413 is not pressed when the loop-reproduction is not performed, or if the loop reproduction start/stop button 413 is pressed when the loop-reproduction is performed, it is judged that the current reproduction mode is not the loop-reproduction mode.

As a result of the judgment in the step S103, if it is judged that the current reproduction mode is not the loop-reproduction mode (the step S103: No), the normal reproduction of the content data is continued without the loop-reproduction or after the loop-reproduction is stopped.

On the other hand, as a result of the judgment in the step S103, if it is judged that the current reproduction mode is the loop-reproduction mode (the step S103: Yes), the loop-reproduction is performed on the content data portion which is specified by each of the loop-in point specified in the step S101 and the loop-out point specified in the step S102, under the control of the system controller 20, which constitutes one specific example of the “first controlling device” of the present invention (step S104). Specifically, the content data portion specified by each of the loop-in point and the loop-out point is repeatedly reproduced.

In particular, in the first operation example, when the loop-reproduction of the content data portion is performed, it is judged whether or not the reproduction direction of the content data portion is the forward direction (step S105). More specifically, if the content data portion is reproduced in the forward direction of the reproduction time axis directed from the loop-in point to the loop-out point, it is judged that the reproduction direction of the content data portion is the forward direction. On the other hand, if the content data portion is reproduced in the reverse direction of the reproduction time axis directed from the loop-out point to the loop-in point, it is judged that the reproduction direction of the content data portion is not the forward direction (i.e. it is the reverse direction).

As a result of the judgment in the step S105, if it is judged that the reproduction direction of the content data portion is the forward direction (the step S105: Yes), then it is judged whether or not the reproduction position of the content data portion has reached the loop-out point (step S106).

As a result of the judgment in the step S106, if it is judged that the reproduction position of the content data portion has not reached the loop-out point (the step S106: No), the operational flow returns to the step S103 and the processes after the step S103 are continued.

On the other hand, as a result of the judgment in the step S106, if it is judged that the reproduction position of the content data portion has reached the loop-out point (the step S106: Yes), the reproduction direction of the content data portion is reversed to the reverse direction, under the control of the system controller 20 (step S107). More specifically, if it reaches the loop-out point when the content data portion is reproduced in the forward direction, then the content data portion is reproduced in the reverse direction directed from the loop-out point to the loop-in point.

On the other hand, as a result of the judgment in the step S105, if it is judged that the reproduction direction of the content data portion is not the forward direction (the step S105: No), then it is judged whether or not the reproduction position of the content data portion has reached the loop-in point (step S108).

As a result of the judgment in the step S108, if it is judged that the reproduction position of the content data portion has not reached the loop-in point (the step S108: No), the operational flow returns to the step S103, and the processes after the step S103 are continued.

On the other hand, as a result of the judgment in the step S108, if it is judged that the reproduction position of the content data portion has reached the loop-in point (the step S108: Yes), the reproduction direction of the content data portion is reversed to the forward direction, under the control of the system controller 20 (step S109). More specifically, if it reaches the loop-in point when the content data portion is reproduced in the reverse direction, then the content data portion is reproduced in the forward direction directed from the loop-in point to the loop-out point.

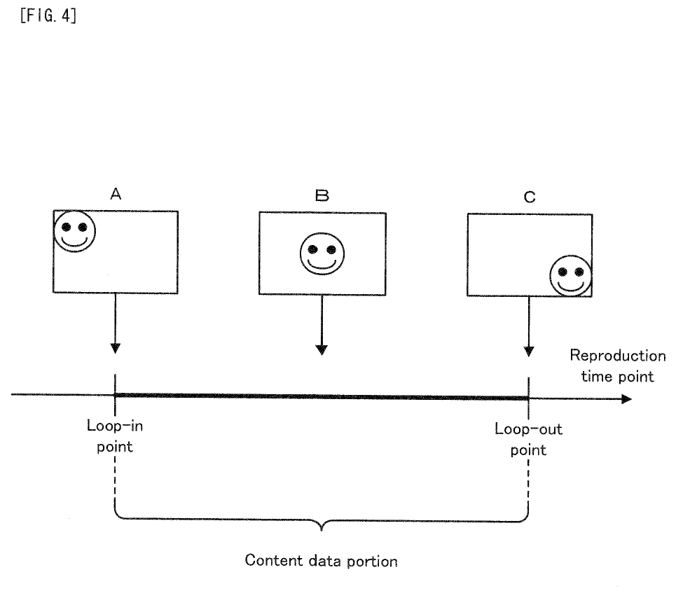

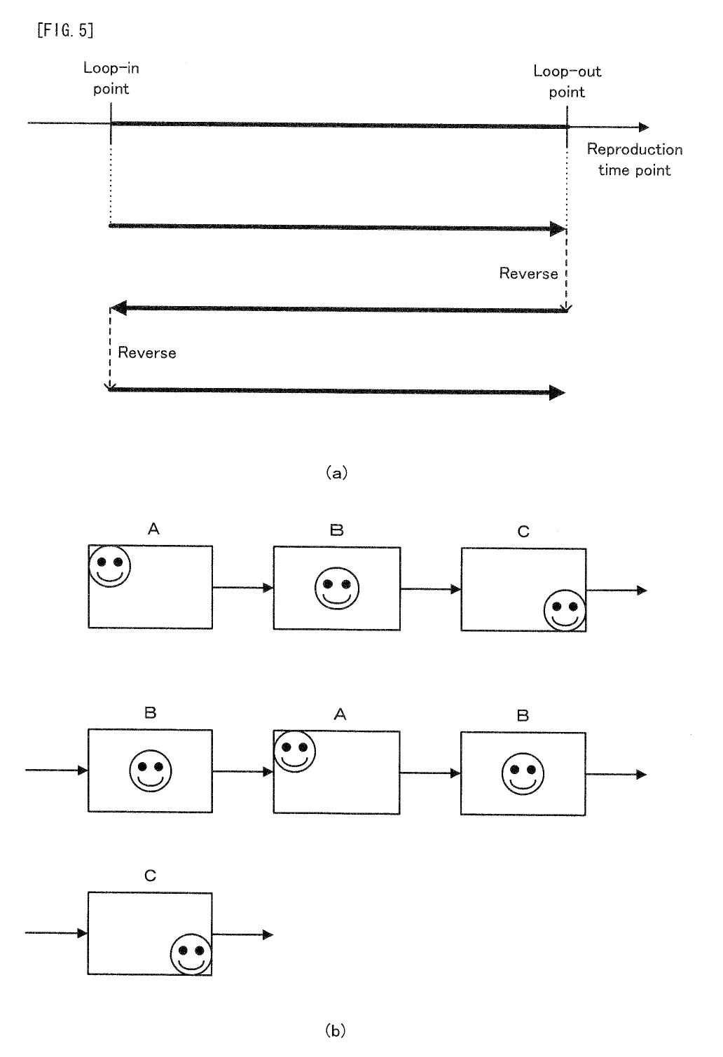

Now, with reference to FIG. 4 and FIG. 5, an explanation will be given on a specific aspect of displaying video images. FIG. 4 is a timing chart conceptually showing content data portion specified by the loop-in point and the loop-out point. FIG. 5 are a timing chart conceptually showing a reproduction position in performing the loop-reproduction in the first operation example, and a plan view conceptually showing the aspect of displaying video images in performing the loop-reproduction in the first operation example.

As shown in FIG. 4, the content data portion to be loop-reproduced is specified by the loop-in point and the loop-out point from among the entire content data.

Here, it is assumed that a video image A of a character's face displayed at the upper left of a display screen, such as a display, is reproduced at the loop-in point, that a video image C of the character's face displayed at the lower right of the display screen, such as a display, is reproduced at the loop-out point, and that a video image B of the character's face displayed on the center of the display screen, such as a display, is reproduced at the intermediate position of the loop-in point and the loop-out point. Therefore, if the content data portion shown in FIG. 4 is reproduced, video images in which the character's face moves from the upper left to the lower right of the display screen, such as a display, are displayed.

If the loop-reproduction shown in FIG. 3 is performed on the content data portion described above, firstly the forward-reproduction of the content data portion is performed from the loop-in point to the loop-out point. Then, after it reaches the loop-out point, the reproduction direction is reversed and the reverse-reproduction of the content data portion is performed from the loop-out point to the loop-in point. Then, after it reaches the loop-in point, the reproduction direction is reversed again and the forward-reproduction of the content data portion is performed from the loop-in point to the loop-out point. Subsequently this operation is repeated if the loop-reproduction is not stopped.

At this time, video images shown in FIG. 5(b) are displayed on the display screen, such as a display. That is, due to the forward-reproduction which is firstly performed, the video images A, B, and C are displayed in this order on the display screen. That is, the video images in which the character's face moves from the upper left to the lower right are displayed. Then, the reproduction direction is reversed and the reverse-reproduction is performed, by which the video images C, B, and A are displayed in this order on the display screen. That is, the video images in which the character's face moves from the lower right to the upper left are displayed. Then, the reproduction direction is reversed and the forward-reproduction is preformed, by which the video images A, B, and C are displayed in this order on the display screen. That is, the video images in which the character's face moves from the upper left to the lower right are displayed.

As described above, since the loop-reproduction is performed with the reproduction direction being reversed at edge points, it is possible to almost or completely eliminate that the video images are unnaturally discontinued during the loop-reproduction. Thus, the user who operates the optical disc reproducing apparatus 1 in the embodiment can perform the loop-reproduction of the content data portion which is seamless or comfortable and which does not stop a flow of video images unnaturally. That is, it is possible to perform the seamless loop-reproduction of the content data portion. On the other hand, the user who watches video images can watch the content data portion which is seamless or comfortable and which does not stop a flow of video images unnaturally.

In addition, the user who operates the optical disc reproducing apparatus 1 in the embodiment can perform the loop-reproduction of the content data portion without any other complicate operations by merely specifying the loop-in point and the loop-out point. Thus, the user who operates the optical disc reproducing apparatus 1 in the embodiment can perform the loop-reproduction in the first operation example by the relatively easy operation.

Moreover, by specifying the loop-in point and the loop-out point in real time or in desired timing, it is possible to extract an arbitrary content data portion in the content data reproduced in real time. Thus, the user can perform the loop-reproduction on the desired content data portion in any timing. That is, it is possible to preferably perform not only the loop-reproduction determined in advance but also the loop-reproduction desired by the user.

After the loop-in point and the loop-out point are specified, the loop-reproduction is performed under the control of the system controller 20. Thus, as compared to the loop-reproduction by the user's operation using the jog dial 41 or the like, the edge points of the loop reproduction are hardly or not shifted at all. Thus, it is possible to perform the highly accurate loop-reproduction.

Incidentally, in the aforementioned embodiment, the loop-in point is specified by the user pressing the loop-in point specification buttons 411 in the desired timing; however, it will be understood that the method of specifying het loop-in point is not limited to this. For example, the loop-in point may be specified by the user directly inputting a reproduction time point or the like that can specify the loop-in point. Alternatively, as long as the loop-in point can be specified, other methods may be employed. The same is true for the specification of the loop-out point.

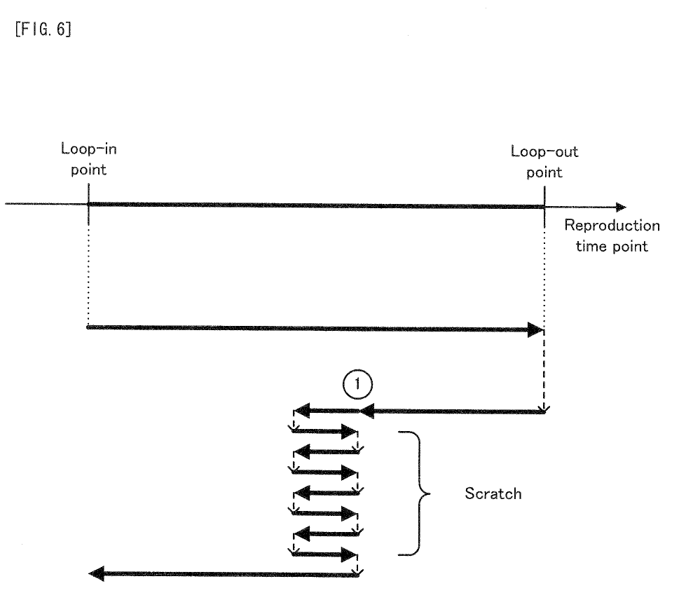

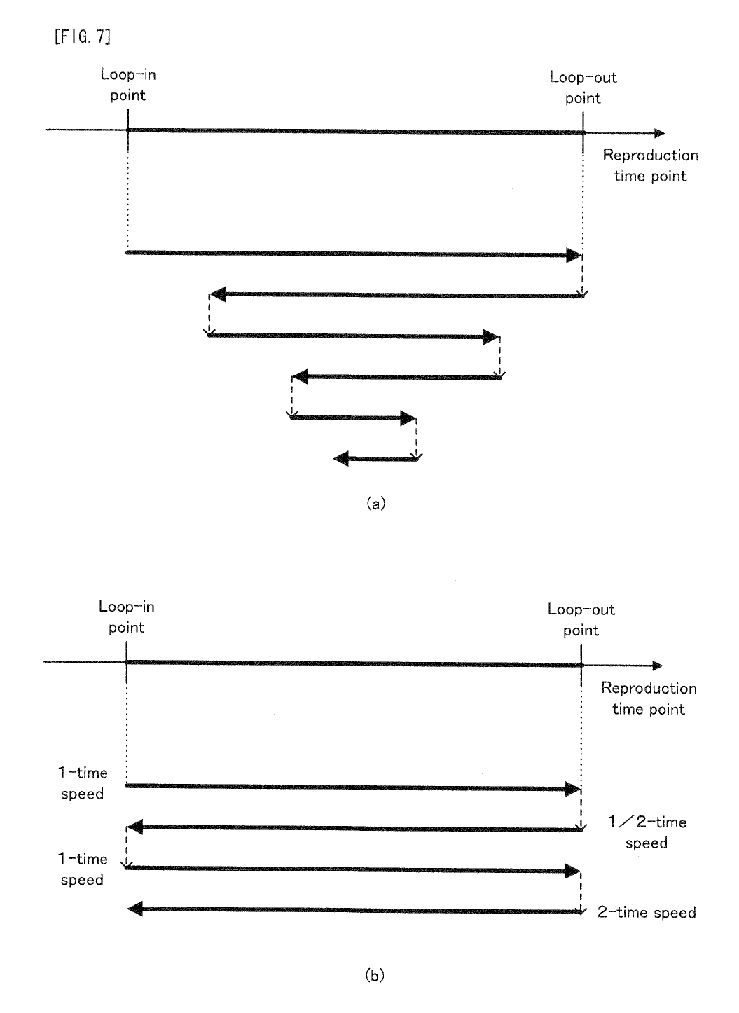

Next, with reference to FIG. 6 and FIG. 7, modified examples of the first operation example will be explained. FIG. 6 is one timing chart conceptually showing the reproduction position in performing the loop-reproduction in a modified example. FIG. 7 are other timing charts conceptually showing the reproduction position in performing the loop-reproduction in modified examples.

As shown in FIG. 6, by operating the jog dial 41 or the like when the loop-reproduction of the content data portion is performed, for example, scratching may be performed during the loop-reproduction, under the control of the system controller 20. Of course, not only the scratching, but also various effect processes may be added which can be added by operations using the operation device 40.

Alternatively, as shown in FIG. 7(a), under the control of the system controller 20, the reproduction time length of the loop-reproduced content data portion may be shorten as the loop-reproduction proceeds. In other words, as the loop-reproduction proceeds, the edge points of the loop reproduction may be set to a position proceeding along the reproduction time axis from the loop-in point and a position going back along the reproduction time axis from the loop-out point.

Alternatively, as shown in FIG. 7(b), the reproduction speed of the content data portion may be changed, as occasion demands, during the loop-reproduction. For example, the forward-reproduction of the content data portion may be performed from the loop-in point to the loop-out point at one-time reproduction speed (or standard tempo), while the reverse-reproduction of the content data portion may be performed from the loop-out point to the loop-in point at an n (n>0)-time reproduction speed (or different tempo from the standard tempo). Alternatively, the reproduction speed may be changed as occasion demands even in the middle of the forward-reproduction of the content data portion, or the reproduction speed may be changed as occasion demands even in the middle of the reverse-reproduction of the content data portion.

Alternatively, in addition to the effect processes shown in FIG. 7(a) and FIG. 7(b), for example, a predetermined modulation process may be performed on the loop-performed content data portion during the loop-reproduction (e.g. modulation by a sawtooth wave, modulation by a rectangular wave, modulation which causes a Doppler effect, modulation by a special waveform that imitates a jet sound, modulation by a special waveform that imitates the bark of a guy, modulation by various special waveforms set in advance by the user or the like). This may be performed by pressing predetermined one button of the effect addition buttons 414 shown in FIG. 2.

The addition of the effect processes explained with FIG. 7 may be performed, for example, by pressing the corresponding button of the effect addition buttons 414 shown in FIG. 2. If the corresponding effect addition button 414 is pressed, the press of the effect addition button 414 may trigger the aforementioned processes, under the control of the system controller 20.

As described above, according to the operations in the modified examples, another effect process or the like can be further added to the content data portion specified by the loop-in point and the loop-out point. That is, the content data portion specified by the loop-in point and the loop-out point is extracted as a first material to which another effect process is to be added later. Then, further another effect process can be also added to the content data portion while performing the lop-reproduction of the content data portion. That is, by using the content data portion extracted as the first material, the content data portion can be reproduced as a second material to which the effect process is added. Thus, it is possible to reproduce the content data portion in a more special aspect or in an aspect of appealing to a viewer.

Incidentally, if the operations in the modified examples shown in FIG. 7 or the like are not performed, the effect addition buttons 414 are not necessarily provided.

### (3) Second Operation Example

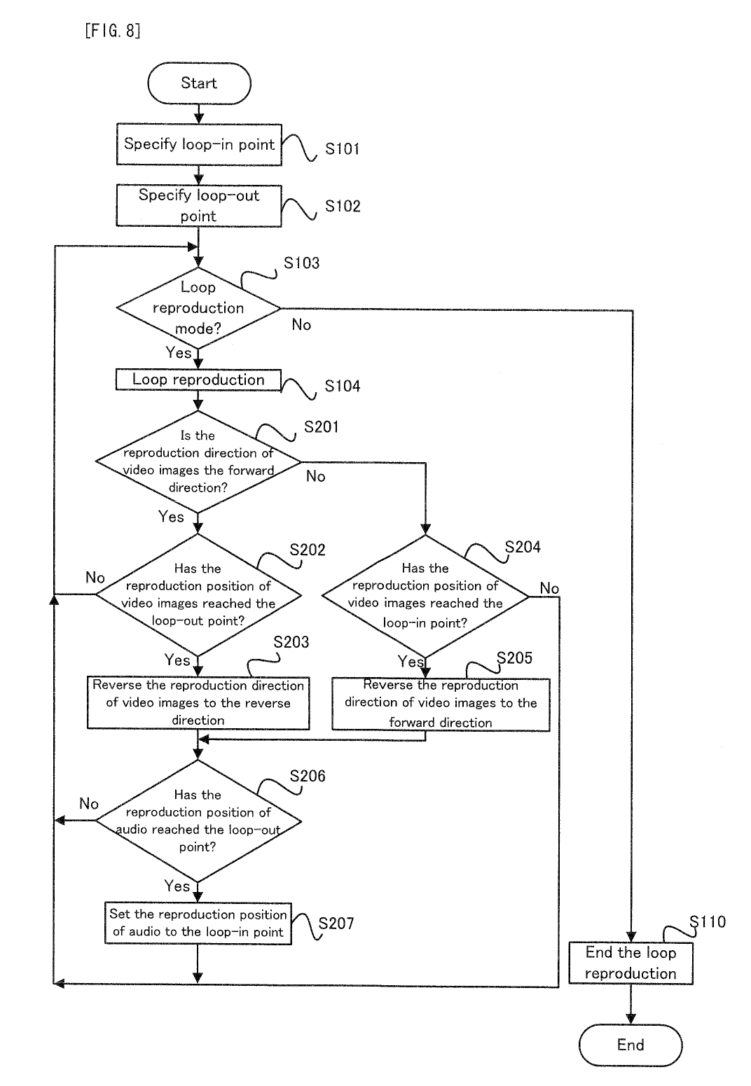

Next, with reference to FIG. 8, an explanation will be given on a second operation example when the optical disc reproducing apparatus 1 in the embodiment performs the loop-reproduction. FIG. 8 is a flowchart conceptually showing a flow of the second operation example when the optical disc reproducing apparatus 1 performs the loop-reproduction.

Incidentally, in the second embodiment, the same constituent elements and processes as those in the first operation example carry the same numerical references and the same step numbers, and the detailed explanation thereof will be omitted.

As shown in FIG. 8, even in the second operation example, the operations in the step S101 to the step S104 are performed, as in the first operation example.

In the second operation example, when the loop-reproduction of the content data portion is performed, it is judged whether or not the reproduction direction of video images of the content data portion is the forward direction (step S201). In other words, without considering the reproduction direction of audio of the content data portion, it is judged whether or not the reproduction direction of video images is the forward direction.

As a result of the judgment in the step S201, if it is judged that the reproduction direction of video images of the content data portion is the forward direction (the step S201: Yes), then it is judged whether or not the reproduction position of video images of the content data portion has reached the loop-out point (step S202).

As a result of the judgment in the step S202, if the reproduction position of video images of the content data portion has not reached the loop-out point (the step S202: No), the operational flow returns to the step S103, and the processes after the step S103 are continued.

On the other hand, as a result of the judgment in the step S202, if the reproduction position of video images of the content data portion has reached the loop-out point (the step S202: Yes), the reproduction direction of video images of the content data portion is reversed to the reverse direction under the control of the system controller 20, which constitutes one specific example of the “second controlling device” of the present invention (step S203). More specifically, if it reaches the loop-out point when the video images of the content data portion are reproduced in the forward direction, then the video images of the content data portion are reproduced in the reverse direction directed from the loop-out point to the loop-in point. Then, the operational flow goes to a step S206.

On the other hand, as a result of the judgment in the step S201, if it is judged that the reproduction direction of the video images of the content data portion is not the forward direction (the step S201: No), then it is judged whether or not the reproduction position of video images of the content data portion has reached the loop-in point (step S204).

As a result of the judgment in the step S204, if it is judged that the reproduction position of video images of the content data portion has not reached the loop-in point (the step S204: No), the operational flow returns to the step S103 and the processes after the step S103 are continued.

On the other hand, as a result of the judgment in the step S204, if it is judged that the reproduction position of video images of the content data portion has reached the loop-in point (the step S204: Yes), the reproduction direction of video images of the content data portion is reversed to the forward direction under the control of the system controller 20 (step S205). More specifically, if it reaches the loop-in point when the video images of the content data portion are reproduced in the reverse direction, then the video images of the content data portion are reproduced in the forward direction directed from the loop-in point to the loop-out point. Then, the operational flow goes to the step S206.

Then, it is judged whether or not the reproduction position of audio of the content data portion has reached the loop-out point (step S206).

As a result of the judgment in the step S206, if it is judged that the reproduction position of audio of the content data portion has not reached the loop-out point (the step S206: No), the operational flow returns to the step S103 and the processes after the step S103 are continued.

On the other hand, as a result of the judgment in the step S206, if it is judged that the reproduction position of audio of the content data portion has reached the loop-out point (the step S206: Yes), the reproduction position of audio of the content data portion is set to the loop-in point under the control of the system controller 20, which constitutes one specific example of the “third controlling device” of the present invention (step S207). Then, again, the audio of the content data portion is reproduced in the forward direction directed from the loop-in point to the loop-out point. That is, the audio of the content data portion is reproduced in the forward direction directed from the loop-in point to the loop-out point, and if it has reached the loop-out point, the reproduction is continued from the loop-in point.

At this time, in order that the audio reproduced at the loop-out point is smoothly connected to the audio newly reproduced from the loop-in point, it is preferable to match the beat or the like in the both audio.

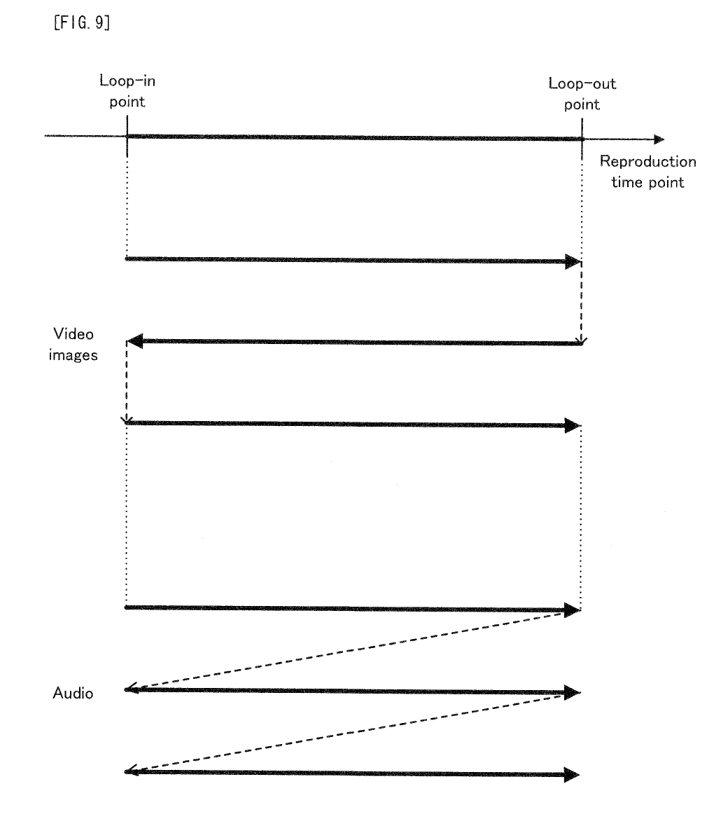

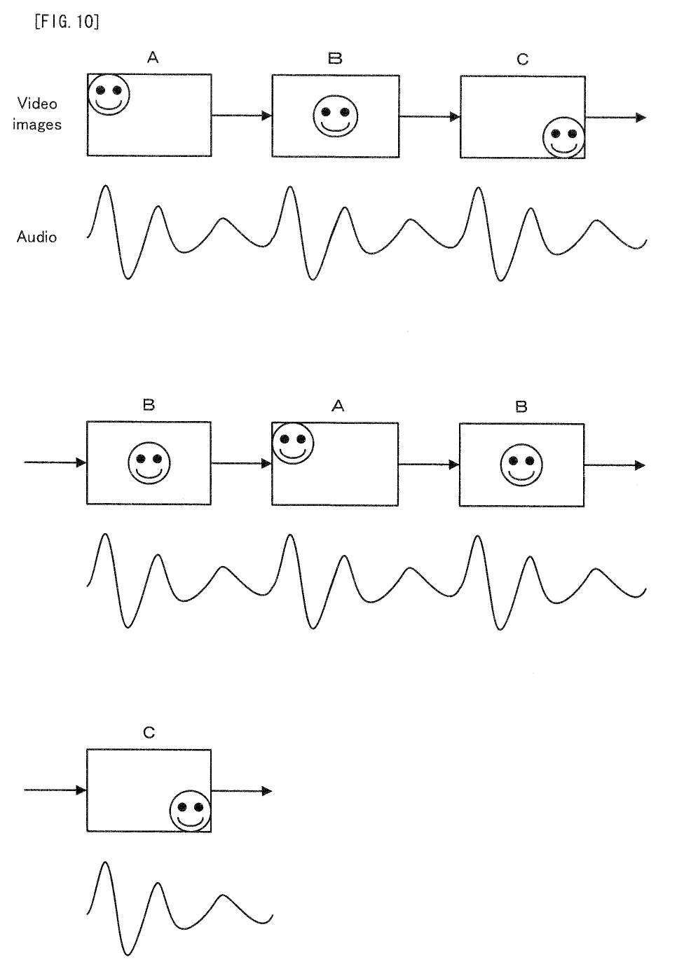

Now, with reference to FIG. 9 and FIG. 10, a specific aspect of displaying video images is explained. FIG. 9 is a timing chart conceptually showing the reproduction position in performing the loop-reproduction in a second embodiment. FIG. 10 is a waveform chart conceptually showing the waveform of audio in performing the loop-reproduction in the second embodiment. Incidentally, in FIG. 9 and FIG. 10, an explanation is given on the case where the loop reproduction in the second embodiment is performed on the content data portion shown in FIG. 4.

When the loop-reproduction shown in FIG. 8 is performed on the content data portion shown in FIG. 4, firstly, the forward-reproduction of video images of the content data portion is performed from the loop-in point to the loop-out point, as shown in the upper part of FIG. 9. Then, after it reaches the loop-out point, the reproduction direction of video images is reversed, and the reverse-reproduction of video images of the content data portion is performed from the loop-out point to the loop-in point. Then, after it reaches the loop-in point, the reproduction direction of video images is reversed again, and the forward-reproduction of video images of the content data portion is performed from the loop-in point to the loop-out point. After that, this operation is repeated if the loop-reproduction is not stopped.

On the other hand, as shown in the lower part of FIG. 9, firstly the forward-reproduction of audio of the content data portion is performed from the loop-in point to the loop-out point. Then, after it reaches the loop-out point, the reproduction position of audio is set to the loop-in point, and the forward-reproduction of audio of the content data portion is performed again from the loop-in point to the loop-out point. After that, this operation is repeated if the loop-reproduction is not stopped.

At this time, video images shown in FIG. 10 are displayed on the display screen, such as a display. That is, firstly by performing the forward-reproduction, video images A, B, and C are displayed in this order on the display screen. That is, video images in which a character's face moves from the upper left to the lower right of the display screen, such as a display, are displayed. Then, the reproduction direction is reversed to perform the reverse-reproduction, by which the video images C, B, and A are displayed in this order on the display screen. That is, the video images in which the character's face moves from the lower right to the upper left of the display screen, such as a display, are displayed. Then, the reproduction direction is reversed to perform the forward-reproduction, by which the video images A, B, and C are displayed in this order on the display screen. That is, the video images in which the character's face moves from the upper left to the lower right of the display screen, such as a display, are displayed.

On the other hand, audio with a waveform shown in FIG. 10 is outputted from a speaker or the like. That is, audio is outputted such that the waveform obtained by forward-reproducing audio of the content data portion repeatedly appears.

As described above, since the loop-reproduction is performed with the reproduction direction being reversed at edge points, it is possible to almost or completely eliminate that the video images are unnaturally discontinued during the loop-reproduction. Thus, the user who operates the optical disc reproducing apparatus 1 in the embodiment can perform the loop-reproduction of the content data portion which is seamless or comfortable and which does not stop a flow of video images unnaturally. That is, it is possible to perform the seamless loop-reproduction of the video images. On the other hand, the user who watches video images can watch the video images which are seamless or comfortable and which do not stop a flow of video images unnaturally.

On the other hand, as for audio, since the loop-reproduction is performed without the reproduction direction being reversed, it is possible to eliminate that the audio is unnaturally reproduced (specifically, reproduced in the reverse direction) in the middle of the loop-reproduction. Thus, the user who operates the optical disc reproducing apparatus 1 in the embodiment can perform the loop-reproduction of audio without reversing a flow of audio unnaturally. That is, it is possible to perform the loop-reproduction of audio which is seamless or comfortable. On the other hand, the user who listens to audio can listen to the audio which is seamless or comfortable and which does not reverse a flow of audio unnaturally.

As described above, according to the second operation example, it is possible to loop-reproduce video images and audio of the content data portion, nonsimultaneously (in other words, individually and independently). Thus, it is possible to loop-reproduce the content data portion including video images and audio, seamlessly or comfortably.

In addition, the user who operates the optical disc reproducing apparatus 1 in the embodiment can perform the loop-reproduction on the content data portion without any other complicate operations by merely specifying the loop-in point and the loop-out point. Thus, the user who operates the optical disc reproducing apparatus 1 in the embodiment can perform the loop-reproduction in the second operation example by the relatively easy operation.

Moreover, by specifying the loop-in point and the loop-out point in real time or in desired timing, it is possible to extract an arbitrary content data portion in the content data reproduced in real time. Thus, the user can perform the loop-reproduction on the desired content data portion in any timing. That is, it is possible to preferably perform not only the loop-reproduction determined in advance but also the loop-reproduction desired by the user.

After the loop-in point and the loop-out point are specified, the loop-reproduction is performed under the control of the system controller 20. Thus, as compared to the loop-reproduction by the user's operation using the jog dial 41 or the like, the edge points of the loop-reproduction are hardly shifted or not shifted at all. Thus, it is possible to perform the highly accurate loop-reproduction.

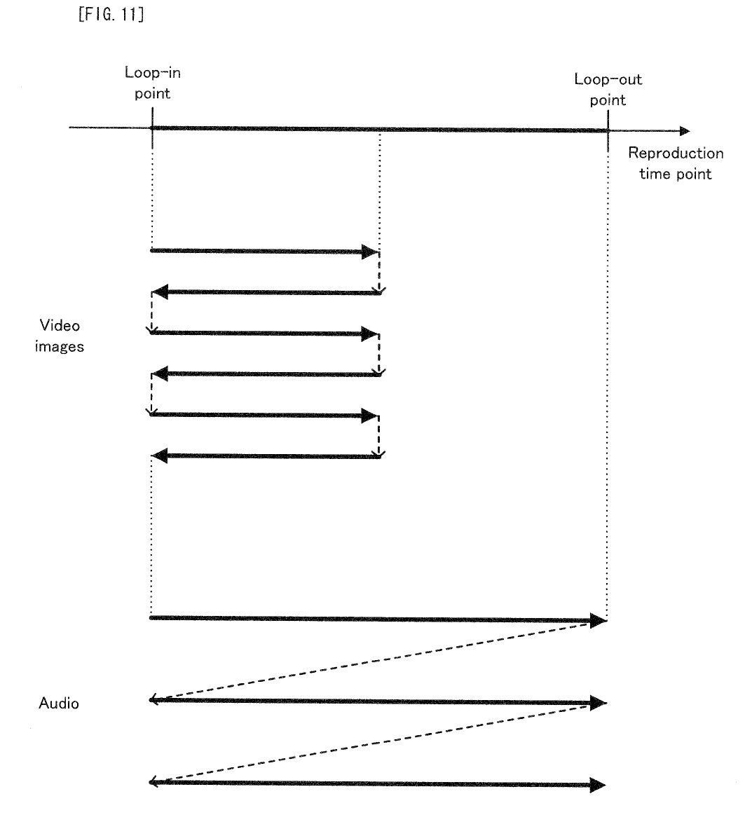

Incidentally, as shown in FIG. 11, the timing to reverse the reproduction direction of video images of the content data portion may be set to a position except the loop-out point. FIG. 11 is a timing chart conceptually showing the reproduction position in performing the loop-reproduction in the second embodiment.

As shown in FIG. 11, the reproduction of video images of the content data portion may be reversed at a midpoint between the loop-in point and the loop-out point. In other words, the cycle of reversing the reproduction direction of video images of the content data portion may be set to a half of the reproduction time length of the content data portion.

By virtue of such construction, when video images are forward-reproduced, audio is also forward-reproduced in the same manner. Thus, it is possible to perform the more comfortable loop-reproduction of the content data portion. That is, it is possible to match the reproduction cycle of video images and the reproduction cycle of audio, relatively easily.

Incidentally, it will be understood that an operation combining the first operation example and the second operation example, as occasion demands, may be performed. Specifically, for example, even in the second operation example, another effect process or the like may be further added to the content data portion. In this case, another effect process or the like may be added to each of the video images and the audio. Alternatively, another effect process or the like may be added to either the video images or the audio.

Moreover, in the aforementioned embodiments, a player (i.e. optical disc reproducing apparatus) related to the optical disc 100 is explained as one example of the information reproducing apparatus; however, the present invention is not limited to the player for the optical disc but can be also applied to players for various information recording media which support high-density recording or high transmission rate. Moreover, it is not limited to a player for obtaining the content data from the information recording medium but can be also applied to a player for obtaining the content data through a broadcast line, or a wired or wireless communication line.

The present invention is not limited to the aforementioned embodiments, but various changes may be made, if desired, without departing from the essence or spirit of the invention which can be read from the claims and the entire specification. An information reproducing apparatus and method, and a computer program, all of which involve such changes, are also intended to be within the technical scope of the present invention.

### INDUSTRIAL APPLICABILITY

The information reproducing apparatus and method, and the computer program according to the present invention can be applied to an information reproducing apparatus, such as DJ equipment. Moreover, they can be applied to an information reproducing apparatus or the like which is mounted on various computer equipment for consumer use or for commercial use, or which can be connected to various computer equipment.

1-6. (canceled)

7. An information reproducing apparatus comprising:
a reproducing device for reproducing content data including video data and audio data;
a specifying device for specifying a reproduction start position and a reproduction end position of a content data portion, which is at least one portion of the content data;
a first controlling device for controlling said reproducing device to loop-reproduce the content data portion after the reproduction start position and the reproduction end position are specified by said specifying device;
a second controlling device for controlling said reproducing device to reverse a reproduction direction of the video data included in the content data portion, at an edge portion of the loop-reproduction of the content data portion; and
a third controlling device for controlling said reproducing device to reproduce the audio data included in the content data portion from the reproduction start position, at an end edge of the loop-reproduction of the content data portion.

8. The information reproducing apparatus according to claim 7, wherein said second controlling device controls said reproducing device to reverse the reproduction direction of the video data included in the content data portion, with using the reproduction start position, the reproduction end position and an intermediate position as the edge portion of the loop-reproduction.

9. The information reproducing apparatus according to claim 7, wherein
said second controlling device
controls said reproducing device to reverse-reproduce the video data from the reproduction end position to the reproduction start position when a reproduction position comes to the reproduction end position, if the video data is forward-reproduced from the reproduction start position to the reproduction end position, and
controls said reproducing device to forward-reproduce the video data from the reproduction start position to the reproduction end position when a reproduction position comes to the reproduction start position, if the video data is reverse-reproduced from the reproduction end position to the reproduction start position.

10. The information reproducing apparatus according to claim 7, further comprising a stopping device for stopping the loop-reproduction of the content data portion.

11. An information reproducing method on an information reproducing apparatus comprising: a reproducing device for reproducing content data including video data and audio data; and a specifying device for specifying a reproduction start position and a reproduction end position of a content data portion, which is at least one portion of the content data, said information reproducing method comprising:
a first controlling process of controlling said
reproducing device to loop-reproduce the content data portion after the reproduction start position and the reproduction end position are specified by said specifying device;
a second controlling process of controlling said reproducing device to reverse a reproduction direction of the video data included in the content data portion, at an edge portion of the loop-reproduction of the content data portion; and
a third controlling process of controlling said reproducing device to reproduce the audio data included in the content data portion from the reproduction start position, at an end edge of the loop-reproduction of the content data portion.

12. A computer program product in a computer-readable medium for tangibly embodying a program of instructions executable by a computer provided in the information reproducing apparatus according to claim 7,
said computer program making the computer function as at least one portion of said first controlling device, said second controlling device, and said third controlling device.
